(19) United States
(12) Patent Application Publication
(10) Pub. No.: US 2010/0236849 A1
(43) Pub. Date: Sep. 23, 2010

(54) Brushless counter-rotating electric apparatus and system

(76) Inventor: Randell J. Wishart, Reno, NV (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/800,949

(22) Filed: May 26, 2010

Related U.S. Application Data
(63) Continuation-in-part of application No. 12/584,557, filed on Sep. 8, 2009.
Application No. 12/584,557 is a continuation-in-part of application No. 12/387,413, filed on May 1, 2009.
(60) Provisional application No. 61/126,320, filed on May 2, 2008.
(60) Provisional application No. 61/137,681, filed on Aug. 1, 2008.
(60) Provisional application No. 61/338,236, filed on Feb. 16, 2010.
(60) Provisional application No. 61/338,540, filed on Feb. 19, 2010.
(60) Provisional application No. 61/343,859, filed on May 5, 2010.

(51) Int. Cl. B60K 7/00; H02K 23/60

(52) U.S. Cl. 180/65.51; 310/115

(57) ABSTRACT

A brushless counter-rotating electric apparatus, motor, wheel hub motor, and associated vehicle includes a brushless counter-rotating electric motor that has oppositely rotating armature and stator components, oppositely rotating armature and stator output drives and, when associated with a vehicle, a control assembly for speed-on/off control of the motor and a portable electric power supply.

### CROSS-REFERENCE TO RELATED APPLICATIONS

This application is a continuation-in-part of copending application Ser. No. 12/584,557 filed on Sep. 8, 2009, which is a continuation-in-part of copending application Ser. No. 12/387,413 filed on May 1, 2009 which claims priority from U.S. provisional applications Ser. No. 61/126,320 filed on May 2, 2008 and Ser. No. 61/137,681 filed on Aug. 1, 2008. This application claims priority from U.S. provisional applications Ser. No. 61/338,236 filed on Feb. 16, 2010, Ser. No. 61/338,540 filed on Feb. 19, 2010, and Ser. No. 61/343,859 filed on May 5, 2010.

### BACKGROUND OF THE INVENTION

1. Field of the Invention

The subject invention relates to an increased efficiency counter-rotating electric apparatus that is configured as a motor or generator. Specifically, the subject invention comprises a brushless counter-rotating DC/AC electric motor or generator, a brushless wheel hub motor, and a brushless motor-containing system for use with virtually any suitable configuration of electric and hybrid vehicle, including wheeled vehicles, preferably a bicycle, a tricycle, a scooter, a motorcycle, a wheelchair, a personal mobility device, an automobile, a truck, and similar vehicles. Additionally, water vehicles, airplanes, helicopters, and equivalent vehicles and other systems comprising mechanical, electric, and electromechanical devices and components that utilize an electric motor as part of their configuration will benefit from incorporation of the subject invention into their operations.

More specifically, in the motor embodiments, the subject invention utilizes a brushless counter-rotating DC/AC electric motor in which both an armature or inner rotational member and a stator or outer rotational member rotate in opposite directions during operation. Generally, the subject motor is configured as a separate motor (that may be mounted is a system as desired) with two oppositely rotating output drives or is mounted at the center of one wheel (hub motor) of a selected wheeled vehicle, wherein the armature output drive means is attached to and extends from the armature of the hub motor to either the same wheel or a second wheel of the vehicle and a wheel and tire extends from the stator of the subject hub motor. For example, with a bicycle, the brushless counter-rotating hub motor may be either the front wheel hub or the rear wheel hub. The front hub is often preferred since multiple sprockets may exit on the rear axle and limit the available space for the hub motor and an associated drive system. As indicated, both the armature (inner rotational member) and the stator (outer rotational member) rotate, in opposite directions, thereby minimizing the creation of heat during operation and accessing torsional forces normally lost by utilizing a traditional motor in which the stator is fixed within the motor housing and the armature rotates (or the armature is fixed and the stator rotates in other equivalent configurations).

2. Description of Related Art

For a traditional brush-containing DC motor, the outside/surrounding motor housing is stationary, as is the stator/field magnets within the housing. Normally, the stator is usually affixed to the housing. An internal armature/rotor is attached to a shaft or axle that rotates during operation (in some versions of a standard motor the rotor may be termed the armature). Thus, the armature shaft/axle extends out from the stationary motor housing and rotates when electrical current is applied to the motor (the armature/rotor rotates within the stationary stator/field magnets). In brush-containing motors, physical brushes are required to transmit the electricity from the outside source to the rotor via a commutator interfacing that pulses the current to alternate the field polarity in the coils of the armature, thereby generating the rotational driving force used to turn the armature. The history of traditional brush-containing electric motors is extensive and one version is found at www.sparkmuseum.com/MOTORS.HTM.

For a traditional brushless DC motor, the outside/surrounding motor housing is, again, stationary, as is the stator within the housing. Normally, the stator is usually affixed to the housing. An internal armature/rotor is attached to a shaft or axle that rotates during operation. Thus, the armature shaft/axle extends out from the stationary motor housing and rotates when electrical current is applied to the motor (the armature/rotor rotates within the stationary stator/field magnets). In brushless motors, physical brushes are not required to transmit the electricity from the outside source to the rotor. The configuration of brushless motors permits either a design utilizing permanent magnets affixed to the stator or, more commonly, the permanent magnets are associated with the armature and the field windings are located in the stationary stator. Clearly, brushless motors do not use physical brushes for commutation; instead, they are electronically commutated by standard techniques. To produce rotational movement, suitably pulsed currents are delivered to the windings and timed via incorporated means such as the application of standard Hall Effect sensors/magnets, back emf, and equivalent means. Brushless DC motors have many well-known advantages over brush-containing motors.

Even though an extremely limited number of specialty counter-rotating brush-containing DC motors are described in published patents (see immediately below), it is stressed that no references have been discovered that utilize, suggest, hint, teach, or imply a counter-rotating electric DC motor that operates via a brushless technology in which both the armature (inner rotational member) and the stator (outer rotational member) physically rotate in opposite directions while maintaining continuous electrical contact with exterior control and power elements.

A counter-rotating electric DC motor is described in related U.S. Pat. Nos. 2,431,255, 2,456,993, and 2,462,182. The disclosed motor was to be used in torpedo propulsion systems in which a coaxial propeller assembly drove separate propellers in opposite directions to aid in keeping the torpedo traveling in a desired direction. Clearly, the operational lifetime of such a motor is extremely limited, given its destruction upon hitting a target. To eliminate necessary centrifugal/centripetal influenced commutator-to-brush contact breaks created while the stator is rotating (normally the stator is not rotating so a constant resilient means or spring simply forces a brush inward and towards the center of rotation, thereby contacting the commutator for the required electrical communication, but rotation of the stator causes the brushes to “float” away from the commutator), the device contained a “radial commutator” (a disk extending outwardly from the axis of rotation) and contact brushes directed parallel to the axis of rotation. This radial commutator/brush design is complex, not easily fabricated, and, thus, expensive to manufacture.

In U.S. Pat. No. 3,738,270 a brushless electric DC motor for a torpedo is disclosed. To maintain stability during its course in water to its target, oppositely rotating propellers are beneficial. The design utilizes a stationary stator around which two independent armatures rotate in opposite directions to drive the associated propellers in corresponding opposite directions.

U.S. Pat. No. 4,056,746 presents a counter rotation electric motor that is quite similar to the design present immediately above ('270). Once again a radial commutator/brush design is utilized in the operation of the device. An interesting analysis of the benefits of a counter-rotating motor is presented: 1) increasing the field cutting speed of the armature to increase power output of the motor; 2) minimizing field collapse; and 3) maintaining the angular rate of the armature which is compatible with the containment of the generated centrifugal forces. There is no discussion, suggestion, implication, or teaching that the related motor was more efficient in using less input energy and producing more output work. It is stressed that it has been discovered that the subject invention dramatically increases the efficiency of subject counter-rotating motor.

A DC rotary machine is related in U.S. Pat. No. 4,259,604. The commutator/brush design in this device is very simplistic and is not created to operate at high rotational velocities. Typically, the motor is used in a machine such as a tape recorder, VTR, and the like that need low rotational speeds. The commutator is of standard cylindrical design and the brushes are contacted in a permanent fashion against the commutator bars.

U.S. Pat. No. 4,375,047 presents a torque compensating electrical motor. This device is comprised of two motors, either next to one another in a serial connection or inside one another. The armature is attached to the axle and is utilized for output work. The stator rotates, but is attached to nothing but the supporting bearings, and is spinning to simply eliminate internal torque and not to produce work. The subject invention utilizes both the rotating armature and the rotating stator to generate work. A critical difficulty exists in this patent since the electrical connection are not described or discussed, except to say that the “motor control are well known and do not form part of the present invention” which is simply not a true and valid statement. The figures show only truncated wires coming from the field coils with no details concerning connection to “outside” power and control means. When counter-rotation of motor components is part of the operation of the device the means for electrical communication is critically important and extremely difficult to achieve. Apparently, the reference to “well known” implies some sort of undisclosed brush/commutator configuration (given the 1983 issue date) or a merely theoretical and non-enabled invention was related.

A rotating-field machine is described in U.S. Pat. No. 4,645,963. In this device, which is extremely similar to '047 immediately above, again, the armature is attached to the axle and is utilized for output work. The stator rotates, but is attached to nothing but the supporting bearings, and is spinning to simply rotate the field and not to produce work. Once again, the subject invention utilizes both the rotating armature and the rotating stator to generate work.

U.S. Pat. No. 5,067,932 discloses a dual-input motor in which two armatures rotate either together or in opposite directions within a stationary/fixed outer stator. The stator is rigidly affixed to a suspension member or other stationary anchor.

A dual rotary AC generator is described in U.S. Pat. No. 5,089,734. This disclosure presents, basically, a motor run in reverse, thereby becoming a generator in which both the magnetic field and armature rotate in opposite directions. Unfortunately, the manner in which the device receives or delivers electricity is not related, nor are any internal electrical components described.

U.S. Patent Publication No.: 2006/0163963 discloses a counter rotating generator. Once again, a radially disposed set of disks are utilized in the commutator/brush design. In this case, the slip rings have a relatively large diameter (which is claimed to decrease heat production) and contact brushes in a continual manner, with constant force, regardless of rotational speed. Additionally, the described generator is used in relatively slow RPM situations in which the wind or manual cranking are utilized as the driving forces, unlike the subject invention that may be operated from relatively low to relatively high RPM values.

### BRIEF SUMMARY OF THE INVENTION

An initial object of the present invention is to provide a brushless counter-rotating DC/AC electric apparatus that may be configured as a generator or a motor.

A second object of the present invention is to provide a brushless counter-rotating electric motor and system for use with a wheeled vehicle (e.g.: a bicycle; a scooter; a tricycle; a quad-cycle, electric powered wheelchair, personal mobility device, automobile, truck, and the like) in which the armature rotates in a first direction and the stator rotates in an opposite second direction about a common central axis and then their opposite rotations are linked to appropriately configured output means to drive one common wheel or at least two wheels of the vehicle over a supporting surface in a common direction.

A third object of the subject invention is to improve the efficiency of a brushless counter-rotating electric motor by accessing torsional forces normally lost to stationary motor mounts that hold the stator or armature in a fixed position.

Another objective of the subject invention is to improve the efficiency of a brushless counter-rotating DC/AC electric apparatus by accessing torsional forces normally lost to stationary anchoring mounts by allowing the stator and armature to rotate freely, wherein the armature and attached armature output means rotates in one direction and the stator rotates in an opposite direction about a common central axis and necessary electrical contact is maintained via at least one electrically conductive grease-containing bearing assembly or equivalent non-brush electrical contact assembly.

Yet a further objective of the subject invention is to improve the efficiency of a brushless counter-rotating electric wheel hub motor for use with a wheeled vehicle by limiting creation of heat and accessing torsional forces normally lost to stationary motor mounts by rotationally securing a wheel and tire to a rotating stator/outer rotational member and a central axle to a rotating armature/inner rotational member and allowing the mated stator to armature assembly to rotate freely with the armature-connected-axle rotating in one direction and a stator-connected-wheel rotating in an opposite direction and then linking the armature-connected-axle rotation to either the same wheel or at least one other wheel on the vehicle so that both wheels rotate in a common direction.

Still yet a further object of the subject invention is to disclose a brushless counter-rotating motor and drive system for a wheeled vehicle that includes an inner rotational member and an outer rotational member that rotate in opposite directions, wherein necessary electrical contact between outside power and control elements and the necessary inside control elements and windings is maintained via at least one electrically conductive bearing or equivalent non-brush electrical contact assembly.

Yet another object of the subject invention is to present a modified bicycle in which a wheel hub motor is adapted to become the subject brushless counter-rotating DC/AC electric motor that includes in the wheel hub motor an inner rotational member and an outer rotational member that rotate in opposite directions, wherein necessary electrical contact between outside power and control elements and the necessary inside control elements and windings is maintained via at least one electrically conductive bearing or equivalent non-brush electrical contact assembly and a first drive output coupled to the outer rotational member powers a first wheel and a second drive output coupled to the inner rotational member powers either the first wheel or a second wheel.

Disclosed is a novel configuration of a brushless counter-rotating DC/AC electric apparatus that is configured as a motor or generator. More specifically, the subject invention comprises a brushless counter-rotating DC/AC electric motor and propulsion system for use with a wheeled vehicle. The subject motor is utilized as either a separate motor with oppositely rotating output drive means of as a wheel hub motor. Comprising the subject vehicle adapted wheel hub motor system is a power supply, a control means, selected wheeled vehicle, and a brushless counter-rotating electric wheel hub motor having two main halves that are rotationally mated with one another: 1) the armature or inner rotational member half and 2) the stator or outer rotational half, both of which freely rotate in opposite directions during operations (unlike traditional motors in which the stator is stationary and normally attached to a motor housing). An axle is connected to and extends from the armature and a stator is rotationally connected to the same axle, with the rotational motion of common axle coupled back to the same wheel or to at least one other wheel on a multi-wheeled vehicle. Suitable rotational bearing assemblies are incorporated within a surrounding housing to support rotational mountings for the axle/armature and stator, including at least one electrically conducting bearing assembly to carry one or more currents between an exterior and interior of the brushless counter-rotating motor or an equivalent non-brush electrical contact assembly. The subject brushless counter-rotating motor contains an electronic control means for commutating electrical pulses to the field magnets to create a rotational driving force (remembering that in traditional brushless motors the stator is a stationary component of the motor and does not rotate).

Either the subject brushless counter-rotating motor or the wheel hub motor is incorporated into a multi-wheeled vehicle as the force creating means for propelling the vehicle. For exemplary purposes only, and not by way of limitation, a bicycle is described as the modified multi-wheeled vehicle and is adapted with a subject wheel hub motor. The subject wheel hub motor may be located as either the front or rear wheel, however, for ease of installation and fabrication simplicity, a front wheel modified bicycle is described below in detail, although the rear wheel modified bicycle is also contemplated as being within the realm of this disclosure. The subject hub motor mounts to a surrounding front wheel and tire via associated spokes or the equivalent and is secured to the front fork of the bicycle either directly or via a supporting framework. The subject wheel hub motor receives electrical current from a bike-mounted battery system which includes necessary standard wiring, and controller (on-off, speed, and the like). The outer rotational member of the subject wheel hub motor (the stator) extends into the front wheel and tire. The rotational power from the rotating inner rotational member (the armature) is transmitted either back to the front wheel by below described means or to the rear wheel via a rear wheel drive train. Preferably, the rear wheel drive train comprises a front sprocket secured to the rotating front axle, one or more chains running from the front sprocket to the rear wheel, and means to permit turning the front fork to steer the modified bicycle. When the power of the rotating armature is coupled back into the same wheel there are no steering interferences. Assuming for exemplary purposes only, and not by way of limitation, a front wheel modified bicycle is considered, clearly, the axle's rotational direction and the rotational direction of the front wheel are opposite, thus, means for pairing the counter-rotating motions into a common rotational direction is also incorporated into the modified bicycle.

Further objects and aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a first embodiment of the subject invention showing a cross-sectional view of the subject brushless counter-rotating motor.

FIG. 2 is a view of the subject invention taken along view-line 2-2 in FIG. 1 and shows the counter-rotating armature and stator within the motor housing.

FIG. 3 is a second embodiment of the subject invention showing a cross-sectional view of the subject brushless counter-rotating wheel hub motor.

FIG. 4 is an enlarged section of FIG. 3 focusing in on the connection of the wire-to-electrically conducting bearings through an electrically insulating barrier.

FIG. 5 is a left side view of a bicycle modified with the second embodiment of the subject invention in which the brushless counter-rotating wheel hub motor drives the front wheel with via the stator rotation and the rear wheel via the armature rotation and associated rear chain drive means.

FIG. 6A is a close-up left side view of the front wheel of the modified bicycle with the second embodiment of the subject invention in which the brushless counter-rotating wheel hub motor drives the front wheel with via the stator rotation and the rear wheel via the armature rotation and associated rear chain drive means.

FIG. 6B is a close-up left side view of the rear wheel of the modified bicycle with the second embodiment of the subject invention in which the brushless counter-rotating wheel hub motor drives the front wheel with via the stator rotation and the rear wheel via the armature rotation and associated rear chain drive means.

FIG. 7A is a third embodiment of the subject wheel hub motor in which the rotational motion of the armature is coupled back into the same wheel that received the rotational motion of the stator and includes electrically conducting bearings and electrically insulating barriers for transmitting power from outside the subject invention to inside the subject invention.

FIG. 7B is a fourth embodiment of the subject wheel hub motor in which the rotational motion of the armature is coupled back into the same wheel that received the rotational motion of the stator (same method as depicted in FIG. 7A) and includes at least one non-brush electrical contact assembly (a different method than depicted in FIG. 7A).

FIG. 7C shows a first embodiment for a non-brush electrical contact assembly that is associated with the subject wheel hub motor depicted in FIG. 7B.

FIG. 7D shows a second embodiment for a non-brush electrical contact assembly.

FIG. 7E shows a second embodiment for a non-brush electrical contact assembly.

FIG. 8 is a right-side view of the armature rotational output-to-same wheel drive means that powers the modified bicycle shown in FIGS. 14-16.

FIG. 9 is a front view of the armature rotational output-to-same wheel drive means that powers the modified bicycle shown in FIGS. 14-16.

FIG. 10 is a front-cross-sectional view of the armature rotational output-to-same wheel drive means that powers the modified bicycle shown in FIGS. 14-16.

FIG. 11 is an exploded view of the armature rotational output-to-same wheel drive means that powers the modified bicycle shown in FIGS. 14-16.

FIG. 12 is a an exploded view of the armature rotational output-to-same wheel drive means that powers the modified bicycle shown in FIGS. 14-16 in which, for clarity, the two meshing drive cogs are laterally displaced from one another.

FIG. 13 is a partial exploded perspective view of the armature rotational output-to-same wheel drive means that powers the modified bicycle shown in FIGS. 14-16.

FIG. 14 is a left-side view of a bicycle modified with the fourth embodiment of the subject invention in which the brushless counter-rotating wheel hub motor drives the front wheel with via the stator rotation and the front wheel via the armature rotation.

FIG. 15 is a left-side close-up view of the front wheel of the bicycle shown in FIG. 14 showing the armature rotational output-to-same wheel drive means.

FIG. 16 is a right-side close-up view of the front wheel of the bicycle shown in FIG. 14 showing the right-side mounting bracket for the armature rotational output-to-same wheel drive means.

FIG. 17 is a fifth embodiment of the subject invention showing a cross-sectional view of the subject brushless counter-rotating wheel hub motor.

FIG. 18 is a sixth embodiment of the subject invention showing a cross-sectional view of the subject brushless counter-rotating wheel hub motor.

### DETAILED DESCRIPTION OF THE INVENTION

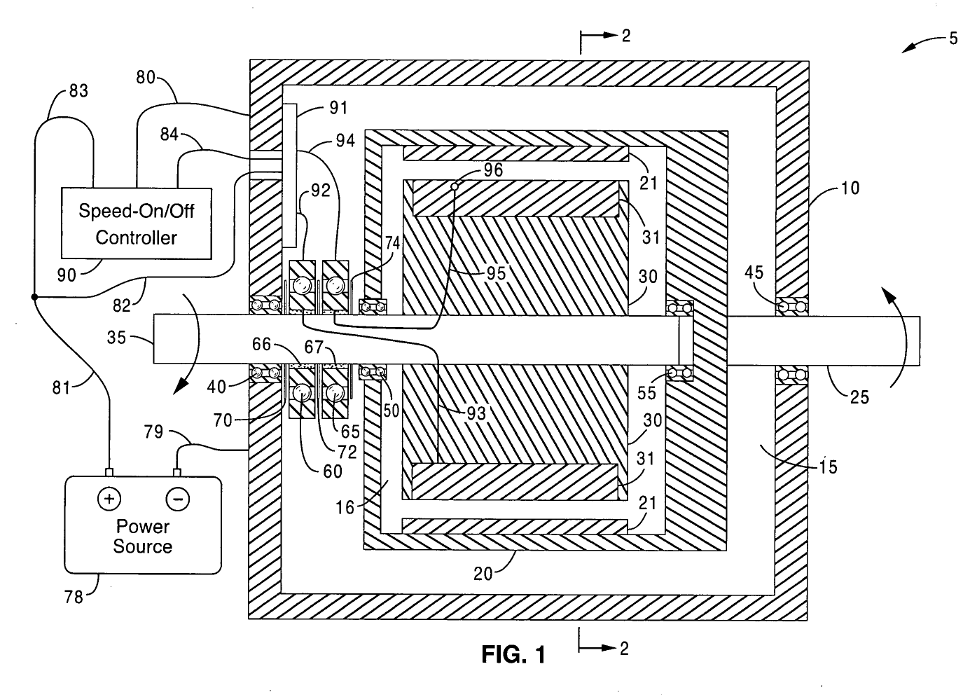

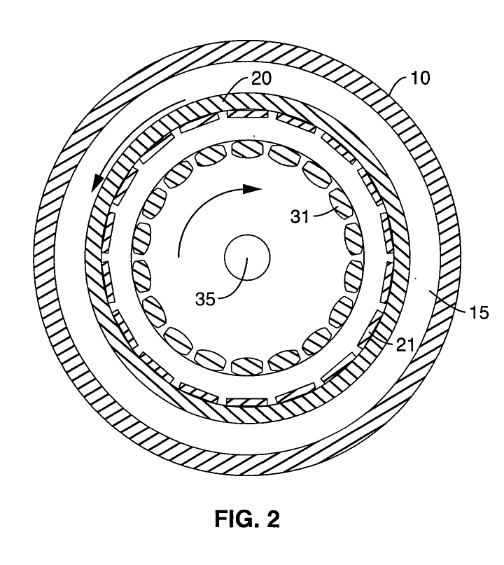

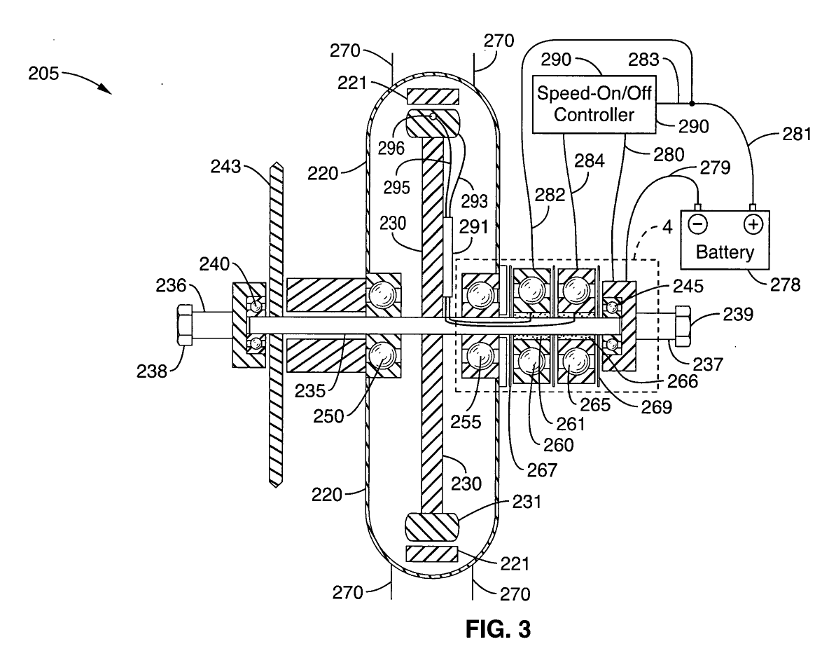

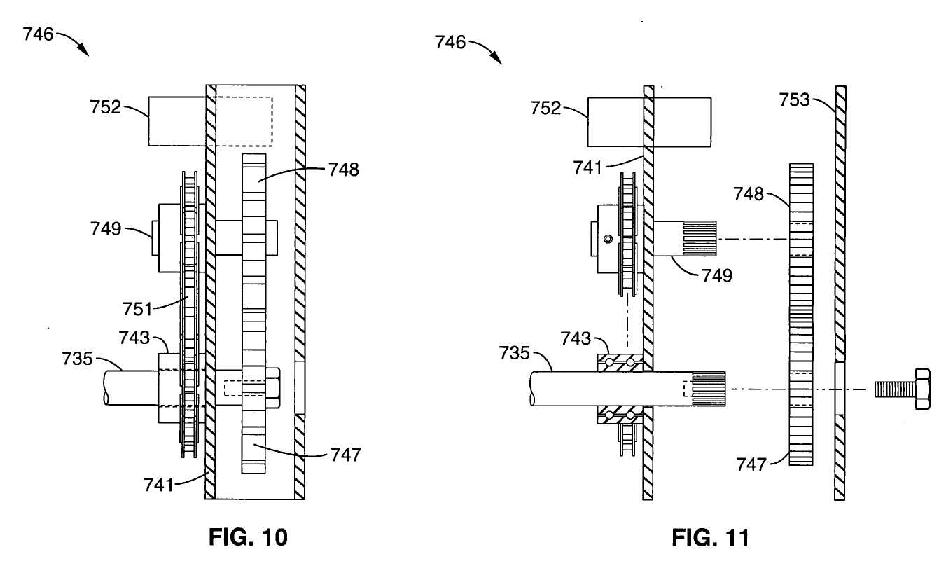

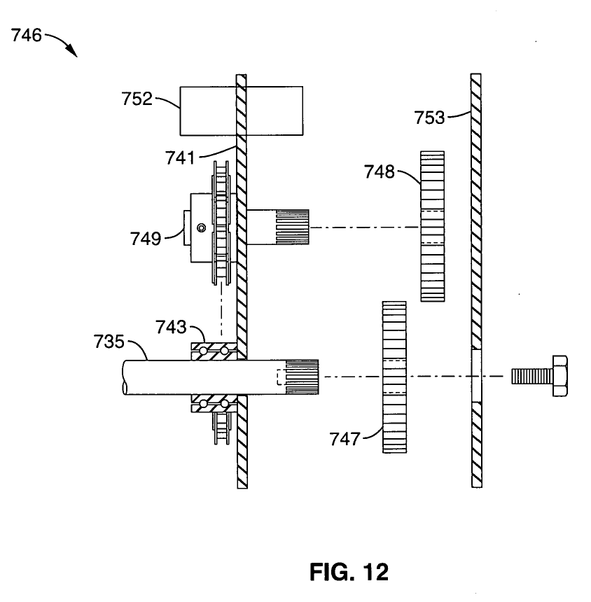

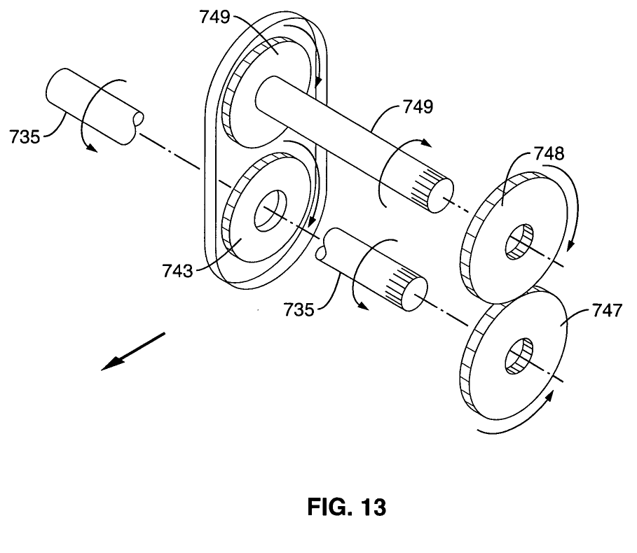

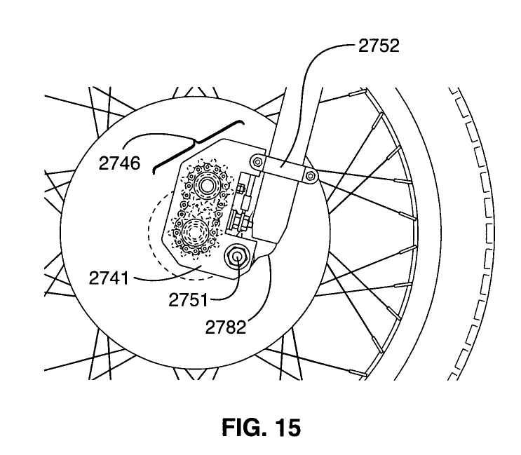

Referring more specifically to the drawings, for illustrative purposes the present invention is presented in the embodiments generally shown in FIGS. 1 and 2 for the generalized version of the subject motor and FIGS. 3-18 for the wheel hub version of the subject motor. It will be appreciated that the subject apparatus and system may vary as to configuration and as to details of the parts without departing from the basic concepts as disclosed herein.

Referring more specifically to the drawings, for illustrative purposes the present invention is presented in the generalized embodiments generally shown in FIG. 1 and FIG. 2. Again, it will be appreciated that the subject apparatus may vary as to configuration and as to details of the parts without departing from the basic concepts as disclosed herein.

Generally, one embodiment of the subject invention is a brushless counter-rotating electric DC/AC motor (FIGS. 3-18 specifically refer to the subject motor mounted in the hub of a wheel). Again, for illustrative purposes only and not by way of limitation, the disclosed subject apparatus is a brushless counter-rotating electric DC motor, but the subject technology applies equally to equivalently configured a counter-rotating electric AC motor, a generator (where the powering force is created by the motion of air, water, and the like rotating the inner and outer rotational members in opposite directions).

In reference to FIGS. 1 and 2, the subject brushless counter-rotating DC/AC motor 5 includes a protective motor housing 10 that may be fabricated from any suitable material. Within the housing 10 is a separation volume 15 (a similar separation volume 16 is found within the stator 20) in which a stator or outer rotational member 20 is rotationally mounted. A stator axle or stator drive shaft 25 is attached to the stator 20. Secured to the inner lining of the stator 20 are permanent magnets 21 (equivalent electromagnets may take the place of permanent magnets and are considered to be within the realm of this disclosure). It is stressed that in this exemplary device the permanent magnets (or equivalent electromagnets) are associated with the stator or outer rotational member and the field windings are on the armature or inner rotational member, but the permanent magnets may be positioned on the armature and the field windings on the stator or, as stated, electromagnets may substitute for the permanent magnets in either location.

Mounted within the stator 20 is an armature or inner rotational member 30 that is attached to a hollow armature axle or armature drive shaft 35. Located proximate the outer perimeter of the armature are the windings or electromagnets 31. To permit rotation of both the armature 30 and stator 20 (counter-rotating to one another), suitable bearing assembles are included. Bearing assemblies 40 and 45 are mounted in the housing 10. Bearing assembly 40 permits the armature axle 35 to rotate within the housing 10 and bearing assembly 45 permits the stator axle 25 to rotate with the housing 10. Bearing assemblies 50 and 55 are mounted in the stator 20 and permit the armature 30 and armature axle 35 to rotate within the stator 20.

Since both the armature 30 and stator 20 are rotating in opposite directions when the brushless motor 5 is operating, it is impossible to deliver current to the windings 31 in the traditional manner. Thus, one or more insulated bearings 60 and 65 are mounted to and encircle the armature axle 35 (each one carrying a desired electric signal or current). Each bearing 40, 45, 50, 55, 60 and 65 is filled with electrically conducting grease (readily obtainable from numerous public suppliers such as: Cool-Amp Conducto-Lube Company or Engineered Conductive Materials, LLC). Each bearing 60 and 65 is electrically insulated from the armature axle 35, upon which they are mounted, by suitable cylindrical insulators 66 and 67. Additionally, bearing 60 and 65 are electrically insulated from neighboring components by suitable insulators 70, 72, and 74.

Electrical connections for the subject system comprise electrically insulated wiring (traditional metal core and electrically insulating outer coating). Electrical power is supplied by a suitable power supply 78, now known or later developed. For a DC power supply a battery is normally utilized. For the AC power supply configuration suitable standard methods and common AC control devices for powering and operating a traditional non-counter-rotating AC motor are appropriately adapted and employed. The power supply is grounded to the housing via wire 79, as is the outside controller via wire 80. Usually, power wire 81 runs to a split point and divides into wire 82 and wire 83. Wire 83 continues from wire 81, at the split point, to the outside speed-on/off controller 90. The outside speed-on/off controller 90 is of standard acceptable configuration for activating and inactivating the subject motor and controlling its operational speed. Power wire 82 continues from wire 81, at the split point, through an aperture in the housing 10 and connects with the inside/internal controller 91.

The internal controller 91 transmits and coordinates the necessary electrical power required to operate the armature windings 31 with suitably pulsed current, pulse time detection means (e.g.: methods utilizing Hall Effect sensors, back EMF techniques, and the like), and other desired operations. The internal controller 91 is illustrated as fastened to the interior surface of the housing 10, but other equivalent locations are considered to be with the realm of this disclosure, including attachment to the rotating armature 30 between the bearing 60 and 65 and the windings 31. Various commercial supply companies sell suitable control units 91, including: the “Brushless Motor Cruise Controller—Programmable via PC USB port, Model BAC281P,” the “High Power Brushless Motor Controller, Model HPC100B,” and several other acceptable models from the Golden Motor Company of China and doing business in the U.S. (www.goldenmotor.com/) and Max Products International, LLC (www.maxxprod.com/).

Power to the windings 31 runs via wire 92 from the internal controller 91 to electrically conducting bearing 60 and then via wire 93, connected to bearing 60 through the associated insulator 66, to the windings 31. Communication between the internal controller 91 and the Hall Effect sensor or sensors 96 (or the equivalent) is by wire 94 to electrically conducting bearing 65 and then via wire 95, connected to bearing 65 through the associated insulator 67, to the sensor(s) 96.

Again, each wire 93 and 95 penetrate the cylindrical insulator 66 and 67, respectively and electrically mate with the electrically conductive parts of each bearing 60 and 65, respectively. The electrically conductive grease permits free rotation of the inner portion of each bearing 60 and 65 while transmitting the electricity to the stationary outer portion of each bearing 60 and 65. The bearings 60 and 65 are electrically connected via wires 92 and 94, respectively, to the internal controller 91.

Since FIG. 2 is a cross-sectional view of the subject invention, the counter-rotational nature of the subject brushless motor is better seen. The two opposing arrows (also depicted in FIG. 1 on the two axles 25 and 35) indicate the counter-rotating directions of the stator 20, with its associated magnets 21, and the armature 30, with its associated windings 31.

The subject device, as noted above, may be utilized as either a motor or generator. The depicted embodiments presented in this disclosure focus on motor applications, but generator applications are also considered to be within the realm of this disclosure. For example, A subject brushless electrical apparatus comprises an outer rotational member that rotates during operation in a first direction, an inner rotational member that rotates during operation in a second direction that is opposite to the first direction, an axle about which the outer and inner rotational members rotate in the opposite directions, electrical conducting windings incorporated into at least one of the rotational members in the apparatus, magnets (permanent or electric magnets) incorporated into at least one of the rotational members in the apparatus, an electrical control system, and brushless means for communicating electrical signals between the windings and the electrical control system.

As a motor system, the subject invention may be utilized in a vast number of devices that require power from a DC/AC motor, in particular, the subject brushless counter-rotating motor may be located within a wheel on a vehicle and may exist in equivalent configurations/embodiments and still be within the realm of this disclosure. Specifically, the subject wheel hub motor is depicted in FIGS. 3-18.

As seen in FIG. 3, the subject brushless counter-rotating wheel hub motor 205 includes a stator or outer rotational member 220. Secured to the inner lining of the stator 220 are permanent magnets 221. It is stressed that in this exemplary device the permanent magnets are associated with the stator or outer rotational member and the windings are on the armature or inner rotational member, but the permanent magnets may be positioned on the armature and the windings on the stator or electromagnets may substitute for the permanent magnets in either location.

Mounted within the stator 220 is an armature or inner rotational member 230 that is attached to a hollow armature axle or armature drive shaft 235. Located proximate the outer perimeter of the armature are windings or electromagnets 231. Axle-to-fork caps 236 and 237 are located at each end of the axle 235 and contain bearing assemblies 240 and 245 (both filled with electrically conducting grease for grounding purposes and readily obtainable from numerous public suppliers such as: Cool-Amp Conducto-Lube Company or Engineered Conductive Materials, LLC). Additionally, the outer portions of caps 236 and 237 are fastened by nuts 238 and 239 to the bicycle fork (the front fork in the exemplary depiction). To permit the additional required rotation of both the armature 230 and stator 220 (counter-rotating to one another), bearing assemblies 250 and 255 (both filled with electrically conducting grease for grounding purposes) facilitate stator 220 rotation about the armature axle 235.

Attached to the armature axle 235 is a sprocket 243 upon which a chain is attached that carries the armature 230 rotational force to the other wheel. It is stressed that a sprocket is utilized in this exemplary description; however, equivalent means to a sprocket-and-chain mechanism for transmitting armature motion to the other wheel are contemplated to be within the realm of this disclosure, including belts, cables, gears, and the like and may incorporated energy storing devices (resilient means, springs, and the like) to delay transmission of the rotational force to the other wheel.

Since both the armature 230 and stator 220 are rotating in opposite directions when the subject brushless motor 205 is operating, it is impossible to deliver current to the windings 231 in any traditional manner. Thus, one or more axle-insulated bearings 260 and 265 are mounted to and encircle the armature axle 235 (each one carrying a desired electric signal or current, usually one for power to the windings and one for communication with the Hall Effect sensor). Each bearing 260 and 265 is filled with electrically conducting grease (again, readily obtainable from numerous public suppliers such as: Cool-Amp Conducto-Lube Company or Engineered Conductive Materials, LLC). Each bearing 260 and 265 is electrically insulated from the armature axle 235, upon which they are mounted, by suitable cylindrical insulators 261 and 266. Additionally, bearings 260 and 265 are electrically insulated from neighboring components by suitable insulators 267, 268, and 269.

Electrical connections for the subject wheel hub motor comprise electrically insulated wiring (again, traditional metal core and electrically insulating outer coating). Electrical power is supplied by a suitable battery 278, now known or later developed (Lead-Acid, Ni—Cd, and the like). The battery is grounded to the bike frame via wire 279, as is the outside controller via wire 280. Usually, power wire 281 runs to a split point and divides into wire 282 and wire 283. Wire 283 continues from wire 281, at the split point, to the outside speed-on/off controller 290. The outside speed-on/off controller 290 is of standard acceptable configuration for activating and inactivating the subject motor and controlling its operational speed. Power wire 282 continues from wire 281, at the split point, and connects via electrically conducting bearing 260 and insulator 261 to the inside/internal controller 291 via wire 285. The speed-on/off controller 290 is connected by wire 284 to electrically conducting bearing 265 and then through insulator 266 and wire 286 to the internal controller 291. Power to the windings 231 from the controller 291 travels via wire 293.

The internal controller 291 transmits and coordinates the necessary electrical power required to operate the armature windings 231 with suitably pulsed current, pulse time detection means 296 (e.g.: Hall Effect sensors, back EMF techniques, and the like) connected to the controller 291 via wire 295. The internal controller 291 is illustrated as fastened to the armature 230. Again, various commercial supply companies sell suitable brushless control units 291, including: the “Brushless Motor Cruise Controller—Programmable via PC USB port, Model BAC281P,” the “High Power Brushless Motor Controller, Model HPC100B,” and several other acceptable models from the Golden Motor Company of China and doing business in the U.S. (www.goldenmotor.com/) and Max Products International, LLC (www.maxxprod.com/).

Again, each wire 285 and 286 penetrate the cylindrical insulators 261 and 266, respectively and electrically mate with the electrically conductive parts of each bearing 260 and 265, respectively. The electrically conductive grease permits free rotation of the inner portion of each bearing 260 and 265 while transmitting the electricity to the stationary outer portion of each bearing 260 and 265. Again, the bearings 260 and 265 are electrically connected via wires 285 and 286, respectively, to the internal controller 291.

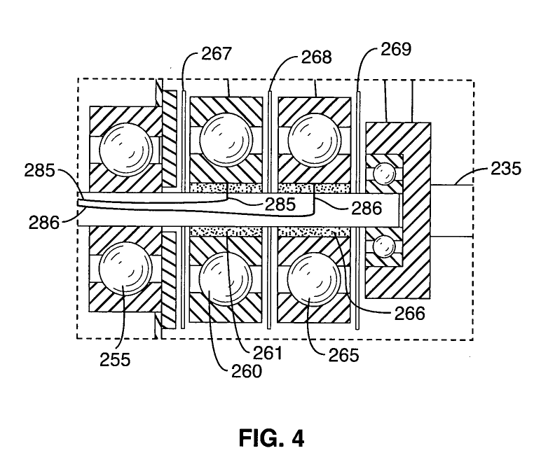

More specifically, FIG. 4 shows an enlarged region of the subject wheel hub invention. Wires 285 and 286 penetrate insulators 261 and 266 and connect to electrically conductive bearings 260 and 265.

The exterior controller 290 may be consolidated and located in one physical location or divided into separate physical locations on the modified vehicle, if desired (e.g.: an on-off switch on one side of the bicycle's handlebars and a speed controller on the other side of the handlebars).

Again, a battery or battery pack 278 is normally included to power the subject device. The battery or battery pack 278 is connected to the electronic elements of the subject system via wires 279 and 281. Frequently, the positive connection 281 runs to the exterior controller 290 and the negative connection 279 runs to an appropriate location of the vehicle's frame, axle, or the like, for grounding.

As is clearly seen in FIG. 3, the stator or outer rotational member 220 is continuous with the outer wheel support 270 that extends into attached spokes, an outer wheel rim, and a tire.

Once again, it is noted that the front wheel, containing the subject brushless counter-rotating motor, is directly connected to the front fork of the subject modified bicycle by central axle 235, but a rear wheel position is also considered within the realm of this disclosure.

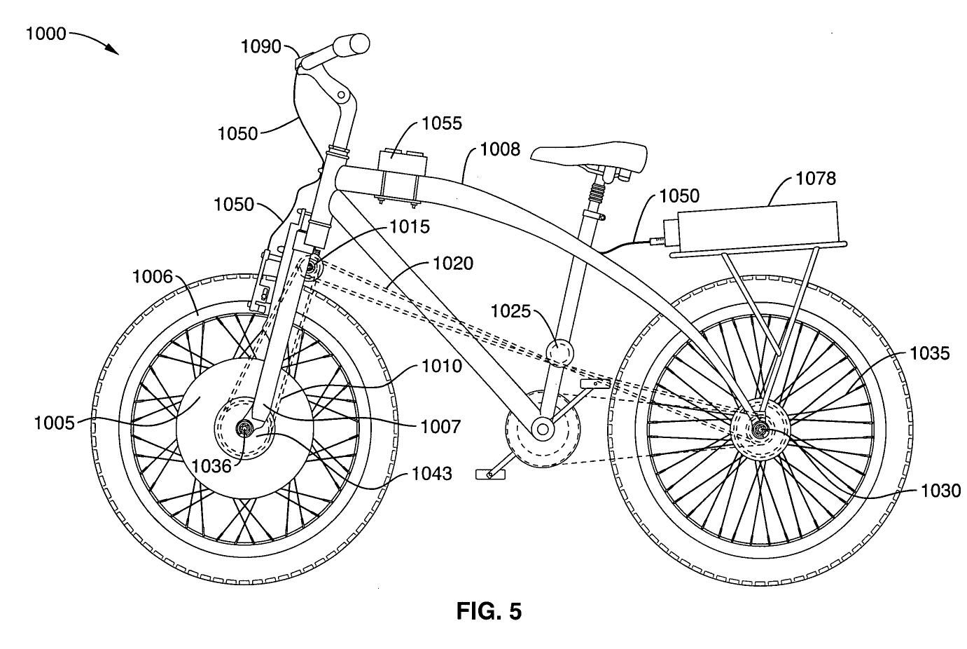

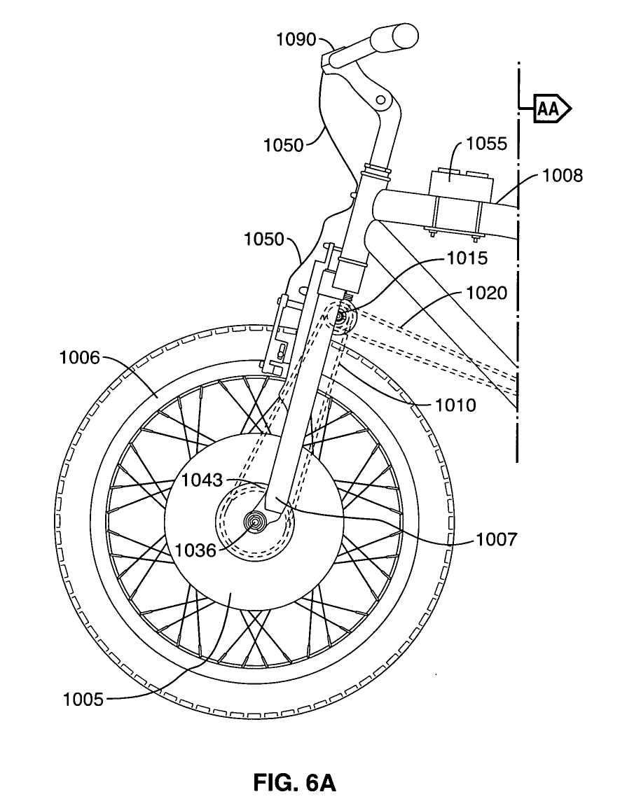

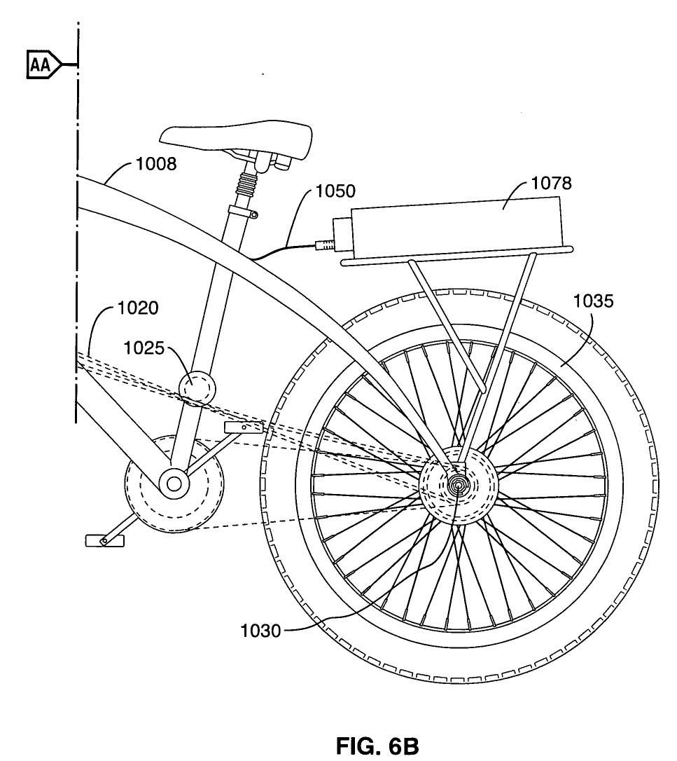

FIGS. 5, 6A, and 6B show a standard bicycle adapted with the subject wheel hub motor 1000. The subject wheel hub motor 1005 is mounted in the front wheel 1006 of the bicycle by the front forks 1007 of the bicycle. The axle-to-fork cap 1036 of the subject wheel hub motor fastens to the fork 1007 via the axle to-fork cap 1036 on the left side of the bike (an equivalent connection exists on the right side of the bike). The hub motor sprocket 1043, attached to the armature of the subject motor mates with a first drive chain 1010 and run to a universal joint containing double sprocket assembly 1015. A second drive chain 1020 travels past a chain tension means 1025 that has two channels, one for the length of chain traveling towards the rear wheel 1035 and the other for the length of chain traveling forward to the front wheel 1006. The chain tension means 1025 serves to keep the passing chain length separated from one another and to keep the slack out of the chain during operation. The second drive chain 1020 twists along the way (to reverse the rotation of the armature to match with the rotation of the stator) and loops onto the rear sprocket 1030 of the rear wheel 1035. It is stressed that, if suitably configured, one long continuous chain may be utilized to replace the two drive chains show in FIGS. 5, 6A, and 6B.

Suitably attached to the frame 1008 of the bicycle is the battery pack 1078. Connection wires 1050 run from the battery pack 1078 into or along the frame 1008, to the speed-on/off controller 1090, and to the subject hub motor 1005. A voltage/current meter 1055 may be associated with the system to track the volts and amps utilized during operation of the subject motor. Usually, the second drive chain 1020 is covered by a chain guard (not shown) to protect a rider.

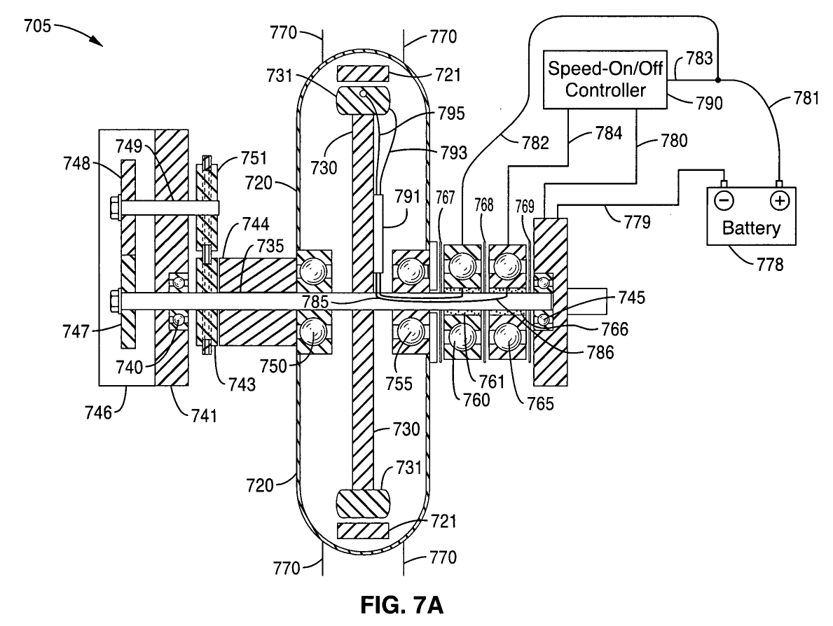

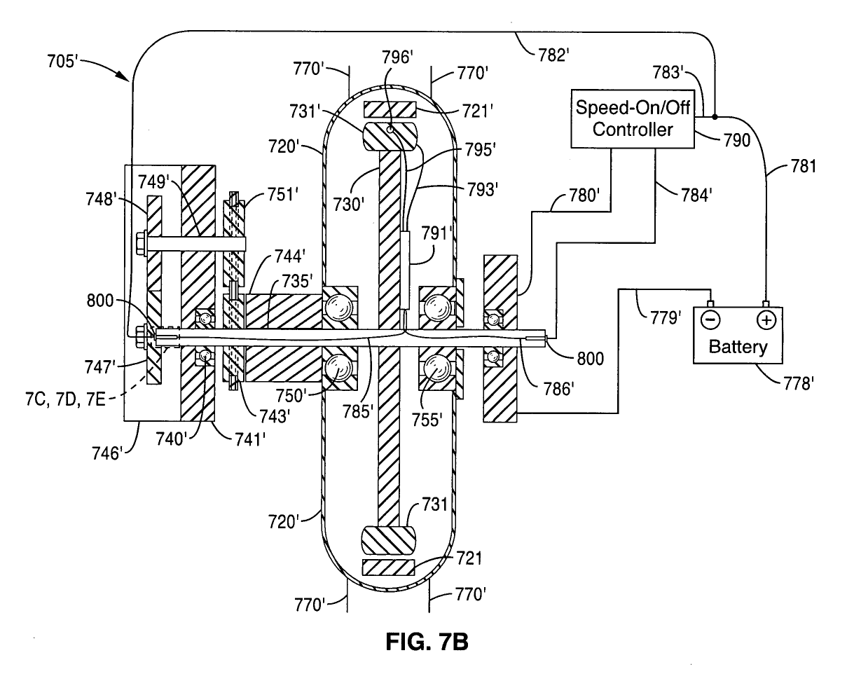

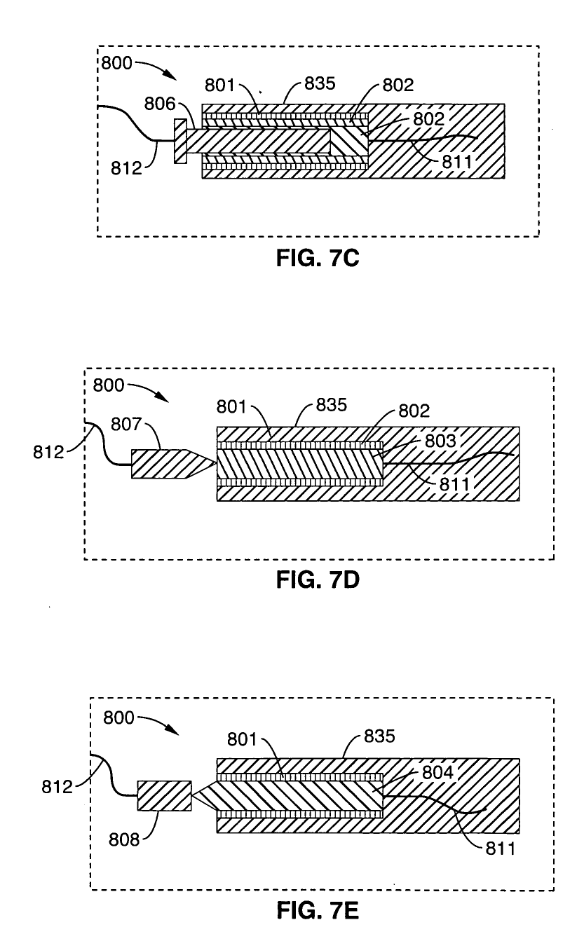

Third and fourth embodiments of the subject wheel hub motor are depicted in FIGS. 7A and 7B, along with a selection of non-brush electrical contact assemblies shown in FIGS. 7C, 7D, and 7E that may be employed in conjunction with the fourth embodiment (specifically depicted in FIG. 7B with the 7C assembly) or the other described embodiments to substitute for the electrically conductive bearings to which power and control wires are fastened.

Specifically, FIG. 7A shows the subject brushless counter-rotating wheel hub motor 705 includes a stator or outer rotational member 720. Secured to the inner lining of the stator 720 are permanent magnets 721. It is stressed that in this exemplary device the permanent magnets are associated with the stator or outer rotational member and the windings are on the armature or inner rotational member, but the permanent magnets may be positioned on the armature and the windings on the stator or electromagnets may substitute for the permanent magnets in either location.

Mounted within the stator 720 is an armature or inner rotational member 730 that is attached to a hollow armature axle or armature drive shaft 735. Located proximate the outer perimeter of the armature are windings or electromagnets 731.

Axle-to-fork brackets 741 and 741 are located proximate each end of the axle 735 and contain bearing assemblies 740 and 745 (both filled with electrically conducting grease for grounding purposes and readily obtainable from numerous public suppliers such as: Cool-Amp Conducto-Lube Company or Engineered Conductive Materials, LLC). To permit the additional required rotation of both the armature 730 and stator 720 (counter-rotating to one another), bearing assemblies 750 and 755 (both filled with electrically conducting grease for grounding purposes) facilitate stator 720 rotation about the armature axle 735.

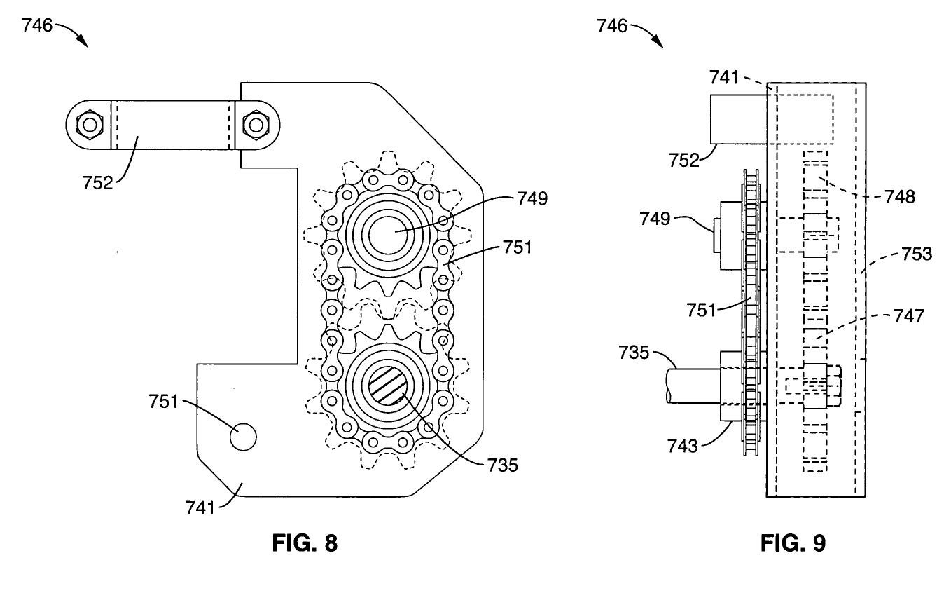

Attached to the armature axle 735 is rotation-reversal assembly 746 that takes the rotational output of the armature axle 735 and converts it into a rotation the matches with the rotation of the stator 720, thereby apply a common rotational force to the same wheel. FIGS. 8-13 illustrate the rotation-reversal assembly 746 and, it is stressed, that equivalent configurations are considered to be within the realm of this disclosure. The armature axle 735 couples to a receiving gear 747, which engages gear 748, which extends into an upper sprocket member 749 and thereby turns lower sprocket member 743 via a connecting chain 751. Lower sprocket member 743 is secured to the stator by cylindrical member 744 to drive the stator. The net result is that the rotational direction of the armature has now been switched to match the rotational direction of the stator so that both rotational forces are coupled to drive the vehicle in a common direction. The rotational-reversal assembly 746 has an outer cover 752 to protect the inner gears. The assembly is mounted to the bicycle via an upper mounting bracket 752 that fastens to the fork arm and aperture 751 that mates with the end of the fork that would normally receive the non-rotating axle of a standard wheel.

As with the other embodiments, since both the armature 730 and stator 720 are rotating in opposite directions when the subject brushless hub motor 705 is operating, it is impossible to deliver current to the windings 731 in any traditional manner. Thus, one or more axle-insulated bearings 760 and 765 are mounted to and encircle the armature axle 735 (each one carrying a desired electric signal or current, usually one for power to the windings and one for communication with the Hall Effect sensor). Each bearing 760 and 765 is filled with electrically conducting grease (again, readily obtainable from numerous public suppliers such as: Cool-Amp Conducto-Lube Company or Engineered Conductive Materials, LLC). Each bearing 760 and 765 is electrically insulated from the armature axle 735, upon which they are mounted, by suitable cylindrical insulators 761 and 766. Additionally, bearings 760 and 765 are electrically insulated from neighboring components by suitable insulators 767, 768, and 769.

Electrical connections for the subject wheel hub motor comprise electrically insulated wiring (again, traditional metal core and electrically insulating outer coating). Electrical power is supplied by a suitable battery 778, now known or later developed (Lead-Acid, Ni—Cd, and the like). The battery is grounded to the bike frame via wire 779, as is the outside controller via wire 780. Usually, power wire 781 runs to a split point and divides into wire 782 and wire 783. Wire 783 continues from wire 781, at the split point, to the outside speed-on/off controller 790. The outside speed-on/off controller 790 is of standard acceptable configuration for activating and inactivating the subject motor and controlling its operational speed. Power wire 782 continues from wire 781, at the split point, and connects via electrically conducting bearing 760 and insulator 761 to the inside/internal controller 791 via wire 785. The speed-on/off controller 790 is connected by wire 784 to electrically conducting bearing 765 and then through insulator 766 and wire 786 to the internal controller 791. Power to the windings 731 from the controller 791 travels via wire 793.

The internal controller 791 transmits and coordinates the necessary electrical power required to operate the armature windings 731 with suitably pulsed current, pulse time detection means 796 (e.g.: Hall Effect sensors, back EMF techniques, and the like) connected to the controller 791 via wire 795. The internal controller 791 is illustrated as fastened to the armature 730. Again, various commercial supply companies sell suitable brushless control units 791, including: the “Brushless Motor Cruise Controller—Programmable via PC USB port, Model BAC281P,” the “High Power Brushless Motor Controller, Model HPC100B,” and several other acceptable models from the Golden Motor Company of China and doing business in the U.S. (www.goldenmotor.com/) and Max Products International, LLC (www.maxxprod.com/).

Again, each wire 785 and 786 penetrate the cylindrical insulators 761 and 766, respectively and electrically mate with the electrically conductive parts of each bearing 760 and 765, respectively. The electrically conductive grease permits free rotation of the inner portion of each bearing 760 and 765 while transmitting the electricity to the stationary outer portion of each bearing 760 and 765. Again, the bearings 760 and 765 are electrically connected via wires 785 and 786, respectively, to the internal controller 791.

The exterior controller 790 may be consolidated and located in one physical location or divided into separate physical locations on the modified vehicle, if desired (e.g.: an on-off switch on one side of the bicycle's handlebars and a speed controller on the other side of the handlebars).

Again, a battery or battery pack 778 is normally included to power the subject device. The battery or battery pack 778 is connected to the electronic elements of the subject system via wires 779 and 781. Frequently, the positive connection 781 runs to the exterior controller 790 and the negative connection 779 runs to an appropriate location of the vehicle's frame, axle, or the like, for grounding.

As is clearly seen in FIG. 7A, the stator or outer rotational member 720 is continuous with the outer wheel support 770 that extends into attached spokes, an outer wheel rim, and a tire.

Once again, it is noted that the front wheel, containing the subject brushless counter-rotating motor, is directly connected to the front fork of the subject modified bicycle by central axle 735, but a rear wheel position is also considered within the realm of this disclosure.

FIG. 7B depicts the fourth embodiment of the subject invention that utilizes the same rotational-reversal assembly as described above for the third embodiment seen in FIG. 7A. However, the fourth embodiment employs a non-brush electrical conductive assembly 800 in place of the insulated electrically conductive bearings to conduct electrical current utilized in the other illustrated embodiments. FIG. 7B uses the same component numbers as those utilized in FIG. 7A except a prime is included. For example in FIG. 7A the armature axle is 735 and in FIG. 7B the armature axle is 735′. Thus, the third and fourth embodiments function is very similar ways except for the electrical communication components. The power wire 782′ and control wire 784′ enter the hollow armature axle 735′ by identical non-brush electrical conductive assemblies 800. One assembly 800 is mounted in each end of the hollow armature axle 735′. Internal wires 785′ and 786′ are each electrically mated with one of the assemblies 800 and continue to the internal controller 791′ in the same fashion as describe for the third embodiment seen in FIG. 7A.

The non-brush electrical conductive assembly 800 can exist in several equivalent configurations, as seen in FIGS. 7C, 7D, and 7E. Specifically, the version seen in FIG. 7C is utilized in the fourth embodiment (FIG. 7B), but the versions illustrated in FIGS. 7D and 7E may acceptably substitute for the FIG. 7C version in any of the subject embodiments. For these three versions the hollow armature axle is designated 835. In all of the versions an electrically insulating sleeve 801 is inserted inside the axle 835. In version “7C” an electrically conducting cylinder 802 (brass or the like) in inserted inside electrically insulating sleeve 801. An electrically conducting pin 806 is fitted inside the conducting cylinder 802. The pin 806 is usually held in place by a suitable resilient means and is sized to easily rotate within the cylinder 802 as the axle 835 spins, thus maintaining electrically contact between interior wire 811 and exterior wire 812.

In a similar fashion, versions “7D” and “7E” maintain electrical contact between interior wire 811 and exterior wire 812 by having a non-rotating electrically conducting rod 803 or 804 fixed within an electrically insulating sleeve 801. In version “7D” the exterior wire 812 is connected to a pointed contact member 807 that spins on the surface of rod 80. In version “7E” the exterior wire 812 is connected to a flat-ended contact member 808 and spins on a point at the end of rod 804. Clearly, in versions “7D” and “7E” a suitable means is incorporated to hold the contact member 807 or 808 in proper contact position (not shown).

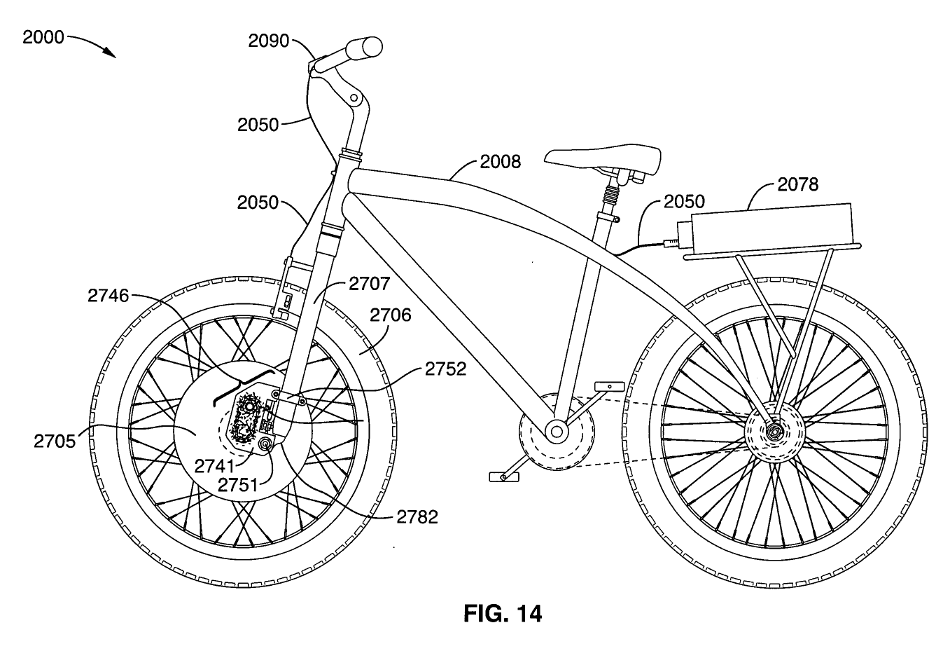

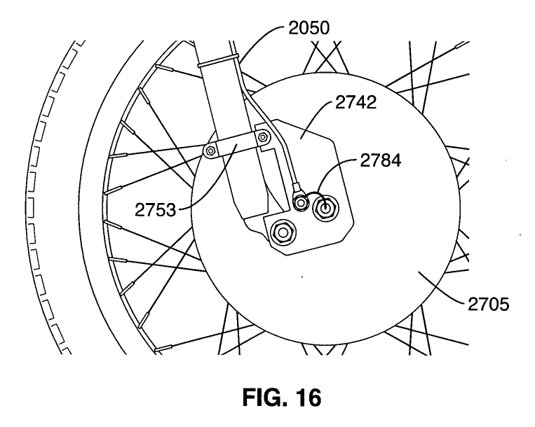

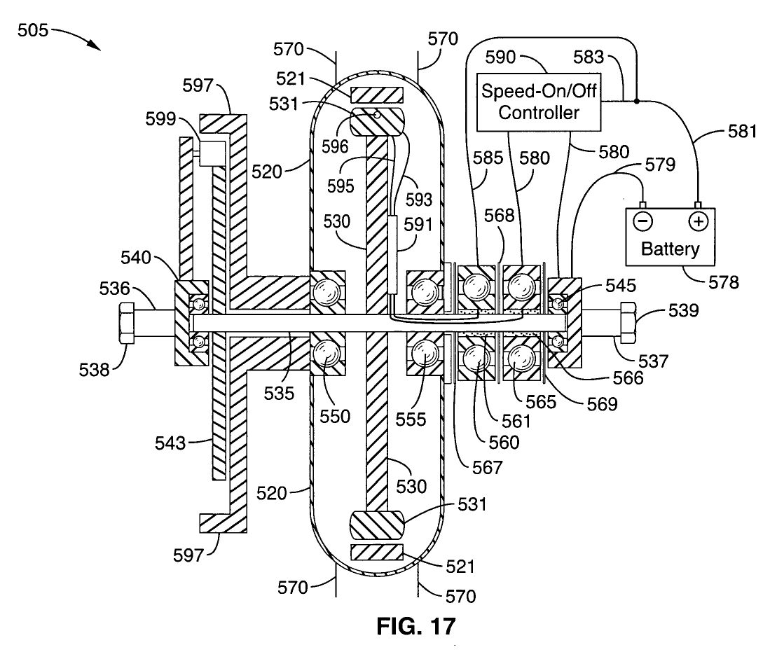

FIGS. 14, 15, and 16 show a standard bicycle adapted with the subject wheel hub motor 2000, wherein the subject wheel hub motor is the one depicted in FIG. 7B. However, it is stressed that the embodiment shown in FIG. 7A is equally suitable as is the embodiment depicted in FIG. 17, described in detail below. The subject wheel hub motor 2705 (this is the FIG. 7B subject wheel hub motor with a new reference numbers since it is now mounted to the bicycle) is mounted in the front wheel 2706 of the bicycle by the front forks 2707 of the bicycle via aperture 2751, a securing bolt/nut, and frame mount 2741. Wire 2782 leads to the hollow armature axle within the rotational-reverse assembly 2746 and then to the interior controller. The subject wheel hub motor 2705 (shown in FIG. 16) is fastened to the other side of the bicycle by a mounting frame 2742 via a suitable aperture and secured by a bolt/nut and fork bracket 2753. Wire 2784 leads to the hollow armature axle and then to the interior controller.

Suitably attached to the frame 2008 of the bicycle is the battery pack 2078. Connection wires 2050 run from the battery pack 2078 into or along the frame 2008, to the speed-on/off controller 2090, and to the subject hub motor 2705. A voltage/current meter may be associated with the system to track the volts and amps utilized during operation of the subject motor (not shown, but equivalent to the one depicted in FIG. 5).

FIG. 17 shows a fifth embodiment of the subject invention in which a rotational-reversal set of gears is included. The result is that, like the embodiments shown in FIGS. 7-16 the opposite rotational outputs of the stator and armature are mated back into the same wheel. The subject brushless counter-rotating wheel hub motor 505 includes a stator or outer rotational member 520. Secured to the inner lining of the stator 520 are permanent magnets 521. It is stressed that in this exemplary device the permanent magnets are associated with the stator or outer rotational member and the windings are on the armature or inner rotational member, but the permanent magnets may be positioned on the armature and the windings on the stator or electromagnets may substitute for the permanent magnets in either location.

Mounted within the stator 520 is an armature or inner rotational member 530 that is attached to a hollow armature axle or armature drive shaft 535. Located proximate the outer perimeter of the armature are windings or electromagnets 531. Axle-to-fork caps 536 and 537 are located at each end of the axle 535 and contain bearing assemblies 540 and 545 (both filled with electrically conducting grease for grounding purposes and readily obtainable from numerous public suppliers such as: Cool-Amp Conducto-Lube Company or Engineered Conductive Materials, LLC). Additionally, the outer portions of caps 536 and 537 are fastened by nuts 538 and 539 to the bicycle fork (the front fork in the exemplary depiction). To permit the additional required rotation of both the armature 530 and stator 520 (counter-rotating to one another), bearing assemblies 550 and 555 (both filled with electrically conducting grease for grounding purposes) facilitate stator 520 rotation about the armature axle 535.

Attached to the armature axle 535 is a gear arm 543 that engages a gear 599 mounted to a support member 598 attached to cap 536. Gear wheel 597 extends from the central portion of the stator 520 and meshes with gear 599. As armature axle 525 rotates the resulting rotation reverses via gear 599 and rotates gear wheel 597 in the same direction as the stator 520 is rotating, thereby coupling oppositely rotating armature 530 and stator 520 into a common rotational direction. Various equivalent configurations (such as a planetary gear assembly or the like) are considered to be within the realm of this disclosure. An exemplary planetary gear assembly would have multiple 599 gears. The sizes of the various gears may vary to produce desired reduction ratios.

Since both the armature 530 and stator 520 are rotating in opposite directions when the subject brushless motor 505 is operating, it is impossible to deliver current to the windings 531 in any traditional manner. Thus, one or more axle-insulated bearings 560 and 565 are mounted to and encircle the armature axle 535 (each one carrying a desired electric signal or current, usually one for power to the windings and one for communication with the Hall Effect sensor). Each bearing 560 and 565 is filled with electrically conducting grease (again, readily obtainable from numerous public suppliers such as: Cool-Amp Conducto-Lube Company or Engineered Conductive Materials, LLC). Each bearing 560 and 565 is electrically insulated from the armature axle 535, upon which they are mounted, by suitable cylindrical insulators 561 and 566. Additionally, bearings 560 and 565 are electrically insulated from neighboring components by suitable insulators 567, 568, and 569.

Electrical connections for the subject wheel hub motor comprise electrically insulated wiring (again, traditional metal core and electrically insulating outer coating). Electrical power is supplied by a suitable battery 578, now known or later developed (Lead-Acid, Ni—Cd, and the like). The battery is grounded to the bike frame via wire 579, as is the outside controller via wire 580. Usually, power wire 581 runs to a split point and divides into wire 582 and wire 583. Wire 583 continues from wire 581, at the split point, to the outside speed-on/off controller 590. The outside speed-on/off controller 590 is of standard acceptable configuration for activating and inactivating the subject motor and controlling its operational speed. Power wire 582 continues from wire 581, at the split point, and connects via electrically conducting bearing 560 and insulator 561 to the inside/internal controller 591 via wire 585. The speed-on/off controller 590 is connected by wire 584 to electrically conducting bearing 565 and then through insulator 566 and wire 586 to the internal controller 591. Power to the windings 531 from the controller 591 travels via wire 593.

The internal controller 591 transmits and coordinates the necessary electrical power required to operate the armature windings 531 with suitably pulsed current, pulse time detection means 596 (e.g.: Hall Effect sensors, back EMF techniques, and the like) connected to the controller 591 via wire 595. The internal controller 591 is illustrated as fastened to the armature 530. Again, various commercial supply companies sell suitable brushless control units 591, including: the “Brushless Motor Cruise Controller—Programmable via PC USB port, Model BAC281P,” the “High Power Brushless Motor Controller, Model HPC100B,” and several other acceptable models from the Golden Motor Company of China and doing business in the U.S. (www.goldenmotor.com/) and Max Products International, LLC (www.maxxprod.com/).

Again, each wire 585 and 586 penetrate the cylindrical insulators 561 and 566, respectively and electrically mate with the electrically conductive parts of each bearing 560 and 565, respectively. The electrically conductive grease permits free rotation of the inner portion of each bearing 560 and 565 while transmitting the electricity to the stationary outer portion of each bearing 560 and 565. Again, the bearings 560 and 565 are electrically connected via wires 585 and 586, respectively, to the internal controller 591.

The exterior controller 590 may be consolidated and located in one physical location or divided into separate physical locations on the modified vehicle, if desired (e.g.: an on-off switch on one side of the bicycle's handlebars and a speed controller on the other side of the handlebars).

Again, a battery or battery pack 578 is normally included to power the subject device. The battery or battery pack 578 is connected to the electronic elements of the subject system via wires 579 and 581. Frequently, the positive connection 581 runs to the exterior controller 590 and the negative connection 579 runs to an appropriate location of the vehicle's frame, axle, or the like, for grounding.

As is clearly seen in FIG. 17, the stator or outer rotational member 520 is continuous with the outer wheel support 570 that extends into attached spokes, an outer wheel rim, and a tire.

Once again, it is noted that the front wheel, containing the subject brushless counter-rotating motor, is directly connected to the front fork of the subject modified bicycle by central axle 535, but a rear wheel position is also considered within the realm of this disclosure.

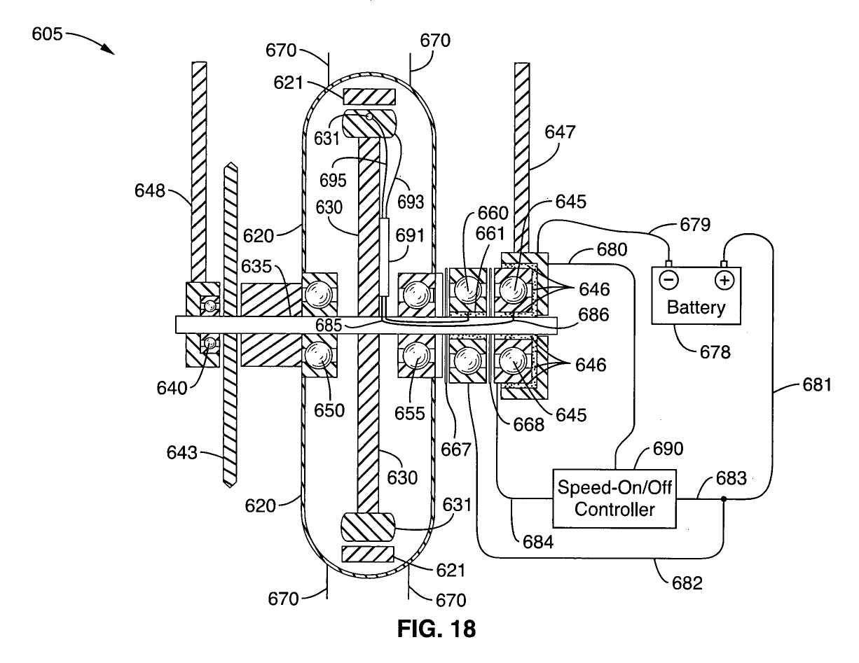

FIG. 18 shows a sixth embodiment of the subject invention in which one fewer electrically conducting bearings is required than, for example, the embodiment shown in FIG. 3. In the sixth embodiment the subject brushless counter-rotating wheel hub motor 605 includes a stator 620 or outer rotational member 620. Secured to the inner lining of the stator 620 are permanent magnets 621. It is stressed that in this exemplary device the permanent magnets are associated with the stator or outer rotational member and the windings are on the armature or inner rotational member, but the permanent magnets may be positioned on the armature and the windings on the stator or electromagnets may substitute for the permanent magnets in either location.

Mounted within the stator 620 is an armature or inner rotational member 630 that is attached to a hollow armature axle or armature drive shaft 635. Located proximate the outer perimeter of the armature are windings or electromagnets 631. Axle-to-bike fork mounting brackets 647 and 648 are located at each end of the axle 635 and contain bearing assemblies 640 and 645 (both filled with electrically conducting grease for grounding purposes and readily obtainable from numerous public suppliers such as: Cool-Amp Conducto-Lube Company or Engineered Conductive Materials, LLC). However, as opposed to the embodiment depicted in FIG. 3, bearing assembly 645 serves for both support/attachment to bracket 647 and for electrical communication between the exterior controller 690 and the interior controller 691, thereby generating an overall motor configuration that requires one fewer bearings than the embodiment shown in FIG. 3. Thus, bearing assembly 645 is electrically insulated from nearby components via a partially surrounding insulator 646. To permit the additional required rotation of both the armature 630 and stator 620 (counter-rotating to one another), bearing assemblies 650 and 655 (both filled with electrically conducting grease for grounding purposes) facilitate stator 620 rotation about the armature axle 635.

Attached to the hollow armature axle 635 is a sprocket 643 upon which a chain is attached that carries the armature 630 rotational force to the other wheel (it is emphasized that the “fewer bearings” sixth embodiment may be utilized with the other embodiments (armature rotation-reversal methods) herein disclosed in which the armature rotation is reversed and coupled back into the same wheel that contains the subject motor). It is stressed that a sprocket 643 is utilized in this exemplary description; however, equivalent means to a sprocket-and-chain mechanism for transmitting armature motion to the other wheel are contemplated to be within the realm of this disclosure, including belts, cables, gears, and the like and may incorporated energy storing devices (resilient means, springs, and the like) to delay transmission of the rotational force to the other wheel.

Once again, since both the armature 630 and stator 620 are rotating in opposite directions when the subject brushless motor 605 is operating, it is impossible to deliver current to the windings 631 in any traditional manner. Thus, one or more axle-insulated bearings 660 and 645 are mounted to and encircle the armature axle 635 (each one carrying a desired electric signal or current, usually one for power to the windings and one for communication with the Hall Effect sensor and bearing 645 also providing bike supporting and mounting means). Each bearing 660 and 645 is filled with electrically conducting grease (again, readily obtainable from numerous public suppliers such as: Cool-Amp Conducto-Lube Company or Engineered Conductive Materials, LLC). Each bearing 660 and 645 is electrically insulated from the armature axle 635, upon which they are mounted, by suitable cylindrical insulator 661 and cylinder/end insulator 646, respectively. Additionally, bearings 660 and 645 are electrically insulated from neighboring components by suitable insulators 667 and 668.

Electrical connections for the subject wheel hub motor comprise electrically insulated wiring (again, traditional metal core and electrically insulating outer coating). Electrical power is supplied by a suitable battery 678, now known or later developed (Lead-Acid, Ni—Cd, and the like). The battery is grounded to the bike frame via wire 679, as is the outside controller via wire 680. Usually, power wire 681 runs to a split point and divides into wire 682 and wire 683. Wire 683 continues from wire 681, at the split point, to the outside/exterior speed-on/off controller 690. The outside speed-on/off controller 690 is of standard acceptable configuration for activating and inactivating the subject motor and controlling its operational speed. Power wire 682 continues from wire 681, at the split point, and connects via electrically conducting bearing 660 and through insulator 661 to the inside/internal controller 691 via wire 685. The speed-on/off controller 690 is connected by wire 684 to electrically conducting bearing 645 and then through insulator 646 and wire 686 to the internal controller 691. Power to the windings 631 from the controller 691 travels via wire 693.

The internal controller 691 transmits and coordinates the necessary electrical power required to operate the armature windings 631 with suitably pulsed current, pulse time detection means 696 (e.g.: Hall Effect sensors, back EMF techniques, and the like) connected to the controller 691 via wire 695. The internal controller 691 is illustrated as fastened to the armature 630. Once again, various commercial supply companies sell suitable brushless control units 691, including: the “Brushless Motor Cruise Controller—Programmable via PC USB port, Model BAC281P,” the “High Power Brushless Motor Controller, Model HPC100B,” and several other acceptable models from the Golden Motor Company of China and doing business in the U.S. (www.goldenmotor.com/) and Max Products International, LLC (www.maxxprod.com/).

Again, each wire 685 and 686 penetrate the cylindrical insulators 661 and 646, respectively and electrically mate with the electrically conductive parts of each bearing 660 and 645, respectively. The electrically conductive grease permits free rotation of the inner portion of each bearing 660 and 645 while transmitting the electricity to the stationary outer portion of each bearing 660 and 645. Again, the bearings 660 and 645 are electrically connected via wires 685 and 686, respectively, to the internal controller 691.

Again, the exterior controller 690 may be consolidated and located in one physical location or divided into separate physical locations on the modified vehicle, if desired (e.g.: an on-off switch on one side of the bicycle's handlebars and a speed controller on the other side of the handlebars).

Once again, a battery or battery pack 678 is normally included to power the subject device. The battery or battery pack 678 is connected to the electronic elements of the subject system via wires 679 and 681. Frequently, the positive connection 681 runs to the exterior controller 690 and the negative connection 679 runs to an appropriate location of the vehicle's frame, axle, or the like, for grounding.

As is clearly seen in FIG. 18, the stator or outer rotational member 620 is continuous with the outer wheel support 670 that extends into attached spokes, an outer wheel rim, and a tire.

Once again, it is noted that the front wheel, containing the subject brushless counter-rotating motor, is directly connected to the front fork of the subject modified bicycle by central axle 635, but a rear wheel position is also considered within the realm of this disclosure.

Testing the Counter-Rotating Motor Modified Boat Trolling Motor for Energy Usage and Efficiency

A Minn Kota Electra 30 outboard motor (a product of Johnson Outdoor, Inc. of Racine, Wis.) was utilized as the standard comparison motor. This is an electric “trolling” motor used to power a fishing boat. An identical motor was modified with the subject technology. A series of controlled tests between the two motors was conducted. Except for the subject invention modification to the Electra 30 motor, all known and relevant variables were held constant. The standard Electra 30 motor had an average energy usage of 348 watts at 29 amps, while the subject-modified Electra 30 had an average energy usage of 228 watts at 19 amps. The modified Electra 30 motor required much less energy to be input than the standard Electra 30 motor for an equivalent level of output work.

Testing the Counter-Rotating Motor Modified Scooter for Energy Usage and Efficiency

Two commonly available electric scooters were employed in a series of side-by-side test. One scooter was a standard scooter that utilized a standard/traditional electric motor. The other scooter was one modified with the subject technology in which the standard/traditional motor was converted into a counter-rotating motor. The results are presented in Table 1 below.

TABLE 1
Counter-Rotating Motor versus Standard Motor in Scooters

| | | | Acceleration | Range in Miles |
|---|---|---|---|---|
| | | Top Speed Amps | and Hill | for One Charge |
| Type of Motor | Top Speed | Drawn | Climbing Ability | of Batteries |
| Counter- | 30 km/hr | 4.5 to 5 Amps | Very good | 51.3 km (32.1 |
| Rotating | | (drops to 4 to 4.5 | acceleration | miles) or 6.5 |
| Motor in | | Amps at an equal | | round-trips on |
| Scooter | | speed for both | | the test track |
| | | scooters, while the | | |
| | | standard scooter | | |
| | | remains at 5.5 to 6 | | |
| | | Amps) | | |
| Standard | 28 km/hr | 5.5 to 6 Amps | Weaker | 35.5 km (22.2 |
| Motor in | | | acceleration | miles) or 4.5 |
| Scooter | | | than the | round-trips on the |
| | | | modified | test track |
| | | | scooter | |

Testing the Brushless Counter-Rotating Wheel Hub Motor Modified Bicycle for Energy Usage and Efficiency

Tests were conducted to establish that the subject invention is more efficient and more powerful in acceleration and hill climbing ability than a non-modified or standard hub motor driven bicycle. The results are presented in Table 2 below.

TABLE 2
Brushless Counter-Rotating Hub Motor versus Standard Hub Motor in Bicycles

| | | | Acceleration | Amp Draw | Range in |
|---|---|---|---|---|---|
| | Voltage and | | and Hill | at 20 mph | Miles for |
| Type of | Type of | Starting | Climbing | on a Level | One Charge |
| Motor | Batteries | Amps Drawn | Ability | Road | of Batteries |
| Brushless | 48 Volts and | 22 Amps | Very Strong | 5.5-6 Amps | 30.5 miles |
| Counter- | Lead-Acid | | Acceleration | | |
| Rotating | Batteries | | and Very | | |
| Hub Motor in | | | Powerful in | | |
| Bicycle | | | Climbing | | |
| (1,000 Watt | | | Hills | | |
| Motor- | | | | | |
| Mostly | | | | | |
| Running | | | | | |
| Below about | | | | | |
| 750 Watts) | | | | | |
| Standard | 48 Volts and | 22 Amps | Strong | 10-12 Amps | 19.8 miles |
| Brushless | Lead-Acid | | Acceleration | | |
| Hub Motor in | Batteries | | and Good | | |
| Bicycle | | | Power in | | |
| (1,000 Watt | | | Climbing | | |
| Motor- | | | Hills | | |
| Mostly | | | | | |
| Running at | | | | | |
| about 1,000 | | | | | |
| Watts) | | | | | |

It is believed that the greatly increased total miles on a single charging of the batteries is due, among other contributing factors, to the subject motor running at a reduced heat level. On a level road the amps drawn by the subject counter-rotating hub motor is approximately half the amps drawn by the standard hub motor. The standard hub motor appears to be losing energy, compared with the subject counter-rotating hub motor, via the generation of wasteful heat.

Therefore, the subject invention vastly increases the efficiency of any mechanical, electrical, and electromechanical systems that utilize the subject counter-rotating electric motor/generator as part of their configuration, in all of its embodiments. Given the small increases in efficiency that are normally found with motor/generator modification, the increased efficiency produced by the subject invention is enormous. The tremendous increase in efficiency is very noteworthy, especially in these days of decreasing availability of fossil fuels, and, quite literally, places the subject invention into an “energy improvement” class not seen before in the field of motor/generator design.

Thus, in consideration of the above detailed embodiments, equivalent embodiments, equivalent adaptations, methods of use, and detailed support, the subject invention comprises, due to its unexpected and dramatic increase in operational benefits of a traditional motor having only one rotational member or even the brush-containing, but radically different in configuration brush-containing two rotational member motors a method for increasing the efficiency of nearly any electrical apparatus that requires a motor or generator. The subject method comprises the steps of selecting a counter-rotating electrical apparatus. The apparatus comprises an outer rotational member that rotates during operation in a first direction about an axis, an inner rotational member that rotates during operation within the outer rotational member in a second direction about the axis that is opposite to the first direction, electrical conducting windings incorporated into at least one of the rotational members in the apparatus, magnets incorporated into at least one of the rotational members in the apparatus, an electrical control system, and means for communicating electrical signals between the windings and the electrical control system. This counter-rotating electrical apparatus is then utilized to increase the efficiency of the electrical apparatus over a traditional electrical apparatus. The apparatus is configured as either a counter-rotating generator or motor.

More specifically, the efficiency of an electric motor associated energy requiring-work producing system may be increased by utilizing the, comprising steps of selecting a counter-rotating electric motor for the system. The system may be any mechanical, electrical, and electromechanical collection of components that incorporate an electric motor and include, but are not limited to: electric/hybrid vehicles, heating/air conditioning applications, computer systems, power generation devices, and, literally, thousands of other equivalent system.

The counter-rotating electric motor that is employed in the vast number of applicable systems comprises an inner rotational member, an outer rotational member, electromagnetic means for creating opposite rotation of said inner and said outer rotational members when an electric current is input into said counter-rotating electric motor, a first drive output means connected to said inner rotational member, a second drive output means connected to said outer rotational member, and means for utilizing said first and said second drive means to produce output work. The counter-rotating motor is then utilized with the associated energy requiring-work producing system to increase the efficiency of the system by including the counter-rotating motor in place of a standard system that uses a traditional motor.

Further, the subject invention comprises a brushless counter-rotating electrical apparatus having an outer rotational member that rotates during operation in a first direction about an axis, an inner rotational member that rotates during operation within the outer rotational member in a second direction about the axis that is opposite to the first direction, electrical conducting windings incorporated into at least one of the rotational members in the apparatus, magnets incorporated into at least one of the rotational members in the apparatus, an electrical control system, and brushless means for communicating electrical signals between the windings and the electrical control system. Additionally, the subject apparatus is configured as either a generator or as a motor.

Also, when the subject invention is configured as a motor the subject invention comprises a brushless counter-rotating electrical motor that includes an outer rotational member that rotates during operation in a first direction about an axis, an inner rotational member that rotates during operation within the outer rotational member in a second direction about the axis that is opposite to the first direction, electrical conducting windings incorporated into at least one of the rotational members in the apparatus, magnets incorporated into at least one of the rotational members in the apparatus, first output drive means coupled to the outer rotational member, second output drive means coupled to the inner rotational member, an electrical control system, and brushless means for communicating electrical signals between the windings and the electrical control system. Often, the electrical conducting windings are mounted to the inner rotational member and the magnets (permanent or electromagnetic) are mounted to the outer rotational member. Further, usually the electrical control system includes a rotational timing method for delivering current to the windings that utilizes techniques selected from a group consisting of Hall Effect sensor methods and back EMF methods.

Additionally, when the subject invention is configured as a motor the subject invention comprises a brushless counter-rotating electrical wheel hub motor having an outer rotational member that rotates during operation in a first direction, an inner rotational member that rotates during operation within the outer rotational member in a second direction that is opposite to the first direction, an axle about which the outer and the inner rotational members rotate in opposite directions, electrical conducting windings incorporated into at least one of the rotational members in the apparatus, magnets incorporated into at least one of the rotational members in the apparatus, first output drive means coupled to the outer rotational member, second output drive means coupled to the inner rotational member, an electrical control system, and brushless means for communicating electrical signals between the windings and the electrical control system. With the subject hub motor the outer rotational member extends into a surrounding wheel. Often, the electrical conducting windings are mounted to the inner rotational member and the magnets (permanent or electromagnetic) are mounted to the outer rotational member. Preferably, the brushless electrical communication means is selected from a group consisting of electrically conducting bearings and non-brush electrical contact assemblies. Additionally, the electrical control system includes a rotational timing method for delivering current to the windings that utilizes techniques selected from a group consisting of Hall Effect sensor methods and back EMF methods.

Further, comprising the subject invention is a brushless counter-rotating electrical motor adapted vehicle that includes a brushless counter-rotating electric motor having an outer rotational member that rotates during operation in a first direction about an axis, an inner rotational member that rotates during operation in a second direction about the axis that is opposite to the first direction, electrical conducting windings incorporated into at least one of the rotational members in the apparatus, magnets incorporated into at least one of the rotational members in the apparatus, first output drive means coupled to the outer rotational member, second output drive means coupled to the inner rotational member, an electrical control system, and brushless means for communicating electrical signals between the windings and the electrical control system. Included is a vehicle to which the brushless counter-rotating electric motor is mounted to power the vehicle, wherein the first and the second output drive means power at least one wheel of the vehicle, and a battery mounted to the vehicle and in electrical communication with the brushless counter-rotating electric motor. Frequently, the electrical conducting windings are mounted to the inner rotational member and the magnets (permanent or electromagnetic) are mounted to the outer rotational member. Preferably, the electrical control system includes a rotational timing method for delivering current to the windings that utilizes techniques selected from a group consisting of Hall Effect sensor methods and back EMF methods.

Additionally comprising the subject invention is a brushless counter-rotating electrical wheel hub motor adapted vehicle having a brushless counter-rotating electric wheel hub motor that comprises an outer rotational member that rotates during operation in a first direction, an inner rotational member that rotates during operation within the outer rotational member in a second direction that is opposite to the first direction, an axle about which the outer and said inner rotational members rotate in opposite directions, electrical conducting windings incorporated into at least one of the rotational members in the apparatus, magnets (permanent or electromagnet) incorporated into at least one of the rotational members in the apparatus, first output drive means coupled to the outer rotational member, second output drive means coupled to the inner rotational member, an electrical control system, and brushless means for communicating electrical signals between the windings and the electrical control system. Also, included is a vehicle to which the brushless counter-rotating electric motor is mounted to power the vehicle, wherein the first and the second output drive means power at least one wheel of the vehicle, and a battery mounted to the vehicle and in electrical communication with the brushless counter-rotating electric motor. Preferably, the outer rotational member extends into a surrounding wheel. Often, the electrical conducting windings are mounted to the inner rotational member and the magnets (permanent or electromagnetic) are mounted to the outer rotational member. Preferably, the brushless electrical communication means is selected from a group consisting of electrically conducting bearings and non-brush electrical contact assemblies. Depending on a selected configuration, the first output drive means and the second output drive means each drive a separate wheel on the vehicle in a common direction or the first output drive means and the second output drive means both couple with one another to drive the same wheel on the vehicle in a common direction.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. A method for increasing the efficiency of an electrical apparatus, comprising the steps:
a. selecting a counter-rotating electrical apparatus, wherein said apparatus comprises:
i. an outer rotational member that rotates during operation in a first direction about an axis;
ii. an inner rotational member that rotates during operation within said outer rotational member in a second direction about said axis that is opposite to said first direction;
iii. electrical conducting windings incorporated into at least one of said rotational members in the apparatus;
iv. magnets incorporated into at least one of said rotational members in the apparatus;
v. an electrical control system; and
vi. means for communicating electrical signals between said windings and said electrical control system and
b. utilizing said counter-rotating electrical apparatus to increase the efficiency of the electrical apparatus over a traditional electrical apparatus.

2. An efficiency increasing method according to claim 1, wherein said apparatus is configured as a counter-rotating generator.

3. An efficiency increasing method according to claim 1, wherein said apparatus is configured as a counter-rotating motor.

4. A method for increasing the efficiency of an electric motor associated energy requiring-work producing system, comprising the steps:
a. selecting a counter-rotating electric motor, wherein said counter-rotating electric motor comprises:
i. an inner rotational member;
ii. an outer rotational member;
iii. electromagnetic means for creating opposite rotation of said inner and said outer rotational members when an electric current is input into said counter-rotating electric motor;
iv. a first drive output means connected to said inner rotational member;
v. a second drive output means connected to said outer rotational member; and
vi. means for utilizing said first and said second drive means to produce output work and
b. utilizing said counter-rotating electric motor with the associated energy requiring-work producing system to increase the efficiency of the system by including said counter-rotating motor in place of a standard system using a traditional motor.

5. A brushless counter-rotating electrical apparatus, comprising:
a. an outer rotational member that rotates during operation in a first direction about an axis;
b. an inner rotational member that rotates during operation within said outer rotational member in a second direction about said axis that is opposite to said first direction;
c. electrical conducting windings incorporated into at least one of said rotational members in the apparatus;
d. magnets incorporated into at least one of said rotational members in the apparatus;
e. an electrical control system; and
f. brushless means for communicating electrical signals between said windings and said electrical control system.

6. A brushless counter-rotating electrical apparatus according to claim 5, wherein said apparatus is configured as a counter-rotating generator.

7. A brushless counter-rotating electrical apparatus according to claim 5, wherein said apparatus is configured as a counter-rotating motor.

8. A brushless counter-rotating electrical motor, comprising:
a. an outer rotational member that rotates during operation in a first direction about an axis;
b. an inner rotational member that rotates during operation within said outer rotational member in a second direction about said axis that is opposite to said first direction;
c. electrical conducting windings incorporated into at least one of said rotational members in the apparatus;
d. magnets incorporated into at least one of said rotational members in the apparatus;
e. first output drive means coupled to said outer rotational member;
f. second output drive means coupled to said inner rotational member;
g. an electrical control system; and
h. brushless means for communicating electrical signals between said windings and said electrical control system.

9. A brushless counter-rotating electrical motor according to claim 8, wherein said electrical conducting windings are mounted to said inner rotational member and said magnets are mounted to said outer rotational member.

10. A brushless counter-rotating electrical motor according to claim 8, wherein said electrical control system includes a rotational timing method for delivering current to said windings that utilizes techniques selected from a group consisting of Hall Effect sensor methods and back EMF methods.

11. A brushless counter-rotating electrical wheel hub motor, comprising:
a. an outer rotational member that rotates during operation in a first direction;
b. an inner rotational member that rotates during operation within said outer rotational member in a second direction that is opposite to said first direction;
c. an axle about which said outer and said inner rotational members rotate in said opposite directions;
d. electrical conducting windings incorporated into at least one of said rotational members in the apparatus;
e. magnets incorporated into at least one of said rotational members in the apparatus;
f. first output drive means coupled to said outer rotational member;
g. second output drive means coupled to said inner rotational member;
h. an electrical control system; and
i. brushless means for communicating electrical signals between said windings and said electrical control system.

12. A brushless counter-rotating electrical wheel hub motor according to claim 11, wherein said outer rotational member extends into a surrounding wheel.

13. A brushless counter-rotating electrical wheel hub motor according to claim 11, wherein said electrical conducting windings are mounted to said inner rotational member and said magnets are mounted to said outer rotational member.

14. A brushless counter-rotating electrical motor according to claim 11, wherein said brushless electrical communication means is selected from a group consisting of electrically conducting bearings and non-brush electrical contact assemblies.

15. A brushless counter-rotating electrical motor according to claim 11, wherein said electrical control system includes a rotational timing method for delivering current to said windings that utilizes techniques selected from a group consisting of Hall Effect sensor methods and back EMF methods.

16. A brushless counter-rotating electrical motor adapted vehicle, comprising:
a. a brushless counter-rotating electric motor, comprising,
i. an outer rotational member that rotates during operation in a first direction about an axis;
ii. an inner rotational member that rotates during operation in a second direction about said axis that is opposite to said first direction;
iii. electrical conducting windings incorporated into at least one of said rotational members in the apparatus;
iv. magnets incorporated into at least one of said rotational members in the apparatus;
v. first output drive means coupled to said outer rotational member;
vi. second output drive means coupled to said inner rotational member;
vii. an electrical control system; and
viii. brushless means for communicating electrical signals between said windings and said electrical control system;
b. the vehicle to which said brushless counter-rotating electric motor is mounted to power said vehicle, wherein said first and said second output drive means power at least one wheel of the vehicle; and
c. a battery mounted to the vehicle and in electrical communication with said brushless counter-rotating electric motor.
d.

17. A brushless counter-rotating electrical motor adapted vehicle according to claim 16, wherein said electrical conducting windings are mounted to said inner rotational member and said magnets are mounted to said outer rotational member.

18. A brushless counter-rotating electrical motor adapted vehicle according to claim 16, wherein said electrical control system includes a rotational timing method for delivering current to said windings that utilizes techniques selected from a group consisting of Hall Effect sensor methods and back EMF methods.

19. A brushless counter-rotating electrical wheel hub motor adapted vehicle, comprising:
a. a brushless counter-rotating electric wheel hub motor, comprising,
i. an outer rotational member that rotates during operation in a first direction;
ii. an inner rotational member that rotates during operation within said outer rotational member in a second direction that is opposite to said first direction;
iii. an axle about which said outer and said inner rotational members rotate in said opposite directions;
iv. electrical conducting windings incorporated into at least one of said rotational members in the apparatus;
v. magnets incorporated into at least one of said rotational members in the apparatus;
vi. first output drive means coupled to said outer rotational member;
vii. second output drive means coupled to said inner rotational member;
viii. an electrical control system; and
ix. brushless means for communicating electrical signals between said windings and said electrical control system;
b. the vehicle to which said brushless counter-rotating electric motor is mounted to power said vehicle, wherein said first and said second output drive means power at least one wheel of said vehicle; and
c. a battery mounted to said vehicle and in electrical communication with said brushless counter-rotating electric motor.

20. A brushless counter-rotating electrical wheel hub motor adapted vehicle according to claim 19, wherein said outer rotational member extends into a surrounding wheel.

21. A brushless counter-rotating electrical wheel hub motor adapted vehicle according to claim 19, wherein said electrical conducting windings are mounted to said inner rotational member and said magnets are mounted to said outer rotational member.

22. A brushless counter-rotating electrical wheel hub motor adapted vehicle according to claim 19, wherein said brushless electrical communication means is selected from a group consisting of electrically conducting bearings and non-brush electrical contact assemblies.

23. A brushless counter-rotating electrical wheel hub motor adapted vehicle according to claim 19, wherein said first output drive means and said second output drive means each drive a separate wheel on the vehicle in a common direction.

24. A brushless counter-rotating electrical wheel hub motor adapted vehicle according to claim 19, wherein said first output drive means and said second output drive means both couple with one another to drive the same wheel on the vehicle in a common direction.
